(19) United States
(12) Patent Application Publication
(10) Pub. No.: US 2016/0065037 A1
(43) Pub. Date: Mar. 3, 2016

(54) ELECTRONIC FLUID PUMP FOR A MOTOR VEHICLE

(71) Applicant: PIERBURG PUMP TECHNOLOGY GMBH, Neuss (DE)

(72) Inventors: FRANK BUERGER, LANGERWEHE (DE); ALESSANDRO MALVASI, LIVORNO (IT); STEFAN OBERHOFF, SOEST (DE); MARTIN SCHUMACHERS, SCHWALMTAL (DE); HARALD SPIERTZ, ERKELENZ (DE); FELIX KOSMAS KOPMEIER, Korschenbroich (DE); ANDREAS WULF, DUESSELDORF (DE); MICHAEL HAASE, ERBACH (DE); VIKTOR SCHROEDER, RATINGEN (DE)

(21) Appl. No.: 14/779,335

(22) PCT Filed: Mar. 25, 2013
(86) PCT No.: PCT/EP2013/056286

§ 371 Date: Sep. 23, 2015

(51) Int. Cl. H02K 11/00; H02K 9/22; F01P 5/12; F01P 3/20; F04D 13/06; F04D 29/18

(52) U.S. Cl. CPC H02K 11/0073; F04D 13/06; F04D 29/18; F01P 5/12; F01P 3/20; H02K 11/0021; H02K 9/22; F01P 2005/125

(57) ABSTRACT

An electronic vehicle fluid pump includes an electronically commutated drive motor. The electronically commutated drive motor includes an electronic motor control unit which includes a first main board, a second main board, at least one flexible conduction band, at least one intermediate board arranged between the first main board and the second main board and electrically connected with the first main board and the second main board via the at least one flexible conduction band, and at least one electronic component arranged on the at least one intermediate board. The first main board, the second main board, and the at least one intermediate board are respectively arranged at a different spatial level.

### CROSS REFERENCE TO PRIOR APPLICATIONS

This application is a U.S. National Phase application under 35 U.S.C. §371 of International Application No. PCT/EP2013/056286, filed on Mar. 25, 2013. The International Application was published in German on Oct. 2, 2014 as WO 2014/154240 A1 under PCT Article 21(2).

### FIELD

The present invention relates to an electronic vehicle fluid pump having an electronically commutated drive motor, which comprises an electronic motor control unit having a plurality of boards.

### BACKGROUND

A board is a plate-shaped element at or on which electronic components can be fastened and supplied with electric energy and/or signals or to which electric energy and/or signals can be applied. The components are connected with each other via tracks.

Semiconductors for directly driving the motor coils and signal-processing semiconductors for logic control are provided in an electronic motor control unit for an electronically commutated drive motor power. The power semiconductors generate much heat, which may affect the signal-processing electronic unit. The power semiconductors may also induce strong interferences into the signal-processing components when steep switching edges are present.

### SUMMARY

An aspect of the present invention is to provide an electronic vehicle fluid pump having a compact electronic motor control unit which allows for a good electric and thermal separation between various electronic assemblies.

In an embodiment, the present invention provides an electronic vehicle fluid pump which includes an electronically commutated drive motor. The electronically commutated drive motor includes an electronic motor control unit which includes a first main board, a second main board, at least one flexible conduction band, at least one intermediate board arranged between the first main board and the second main board and electrically connected with the first main board and the second main board via the at least one flexible conduction band, and at least one electronic component arranged on the at least one intermediate board. The first main board, the second main board, and the at least one intermediate board are respectively arranged at a different spatial level.

### BRIEF DESCRIPTION OF THE DRAWINGS

The present invention is described in greater detail below on the basis of embodiments and of the drawings in which:

FIG. 1 shows a longitudinal section of an electronic vehicle fluid pump having an installed flexible circuit board structure;

FIG. 2 shows a perspective representation of the flexible circuit board structure in the unfolded state;

FIG. 3 shows a representation of the flexible circuit board structure with a folded-up sensor board; and

FIG. 4 shows a top view of the flexible circuit board structure.

### DETAILED DESCRIPTION

The electronic motor control unit comprises a first main board and a second main board. These two main boards carry the electronic components of various electronic assemblies. An intermediate board is arranged between the two main boards at a spatial level deviating from the orientation of the main boards. The intermediate board is electrically connected with the two main boards, respectively, by a flexible conduction band, thereby connecting the two main boards both mechanically and electrically with each other. The intermediate board also comprises at least one electronic component.

In an embodiment of the present invention, the two main boards can, for example, be of a considerably larger configuration as compared with the intermediate board. As a result, the main boards comprise a substantially larger number of electronic components.

The first main board can, for example, comprise power semiconductors, and the second main board can, for example, comprise signal-processing semiconductors. Due to the functionally separated arrangement of the components on different boards, the components are thermally and electrically separated from each other in addition to being spatially separated.

The signal-processing components are thus prevented from being strongly heated or otherwise affected by the power semiconductors.

The flexible conduction bands and the intermediate board allow for heat transfer to be minimized. The flexible conduction bands also allow for any type of folding so that a compact design can be realized. The intermediate board also allows for the two main boards to be electrically decoupled from each other.

The motor control unit is defined by a flexible board structure. The folding types offer large placing areas. This allows for an easy-to-establish and mechanically reliable contacting of the components.

In an embodiment of the present invention, the first main board can, for example, comprise a plurality of power semiconductors so as to define a power board. The second main board does not comprise any power semiconductors since all power semiconductors are arranged on the first main board. The first main board is to be placed in an optimum manner to provide good cooling. In order to avoid long signal paths, the second main board can be placed closer to the signal line of the motor control unit. The two main boards can thus be arranged in an optimum manner with regard to their functions.

In an embodiment of the present invention, the second main board can, for example, comprise a plurality of signal-processing components as well as a processor so as to define a signal-processing board. Both the power board and the signal-processing board are of a modular configuration. The strictly modular configuration allows switching changes to be more easily performed within the power electronic unit or the signal-processing components since they do not influence the track layout of the respective other module.

In an embodiment of the present invention, the motor control unit can, for example, have a butterfly-type symmetry of the two unfolded main boards. Due to this arrangement, the power board and the signal-processing board nearly completely overlap each other in the folded state. This folded state corresponds to the state of operation of the motor control unit.

Using the intermediate board, the two main boards may be arranged so that they form a Z-shape with respect to each other. The two main boards and the intermediate board can, for example, be arranged with respect to each other so that they form a U-shape. The transverse connection between the two main boards is formed by the intermediate board in the U-shaped folding. The intermediate board at the same time defines the distance between the two main boards.

In an embodiment of the present invention, the flexible conduction bands can, for example, be respectively connected integrally and in a plug-free manner with the associated main board and the intermediate board. All boards of the motor control unit and the conduction bands thus form a single part. The flexible conduction bands which connect the boards with each other are thus configured by the board body to have a considerably reduced material thickness in these areas. The reduction of the material thickness is realized by a material removal processes, such as, for example, by milling. The flexible conduction bands are produced in this manner. These flexible conduction bands cannot, however, be bent as often as desired or in a narrow radius. The flexible conduction bands do allow for a single bending which is sufficient for installation purposes.

Due to the integral design, no plugs need be provided to connect the conduction bands and the boards. The integral design prevents errors during assembly or installation, results in a reduced weight, and offers a reliable electric connection since incorrect plug connections are avoided.

The flexible conduction bands and boards are, for example, made from polyester, polyethylene naphthalate, or polyamide. The flexible conduction bands offer the advantage that their shapes can be adapted to more complex shapes of housings, i.e., the interior of the housing can be used particularly efficiently. The flexible conduction bands are normally flexible enough to allow for a bending at a bending edge at an angle of up to 120°, wherein, in practice, a bending angle in the range of 90° normally suffices.

In an embodiment of the present invention, a signal-decoupling electronic unit can, for example, be arranged on the intermediate board. This signal-decoupling electronic unit may comprise both passive and active electronic components. Providing the signal-decoupling electronic unit on the intermediate board prevents interference signals from the signal-processing electronic unit from being transmitted to the power electronic unit and/or vice versa. The isolation of the power electronic unit by the signal-decoupling electronic unit on the intermediate board reliably prevents interferences of the power electronic unit from being fed into the on-board electrical system of the vehicle electronic unit.

In an embodiment of the present invention, a separate sensor board can, for example, be provided which is connected with a respective one of the two main boards, for example, with the signal-processing board, via another flexible conduction band. The signal-processing board may thus be placed close to the signal acceptance unit. This allows for a better signal quality. The signal-processing board may, for example, be integrally formed with the respective main board so that, from the manufacturing perspective, no further board need be separately manufactured.

In an embodiment of the present invention, the signal-processing board can, for example, be populated on two sides. Populating on two sides creates a larger placing area.

In an embodiment of the present invention, the power board can, for example, be populated on one side. The one side of the power board is populated with electronic components. Heat may be dissipated via the unpopulated side of the power board by completely placing the unpopulated side directly on a cooling body.

In an embodiment of the present invention, the unpopulated side of the power board can, for example, be thermally connected with the housing of a separating can via a heat conduction. The separating can bathes in the fluid on the wet side and is thus permanently cooled. This location is suitable for cooling the power electronic unit.

The transfer of heat from the populated side to the unpopulated side can be improved by through-hole contacting.

The heat conduction provides a homogeneous heat distribution which further allows the temperature detection and higher power losses in the power components to be optimized.

In an embodiment of the present invention, the sensor board can, for example, be populated with a rotor position sensor, for example, a Hall sensor. This Hall sensor can detect the current position of the motor rotor.

In an embodiment of the present invention, the power board and/or the signal-processing board can, for example, be fixed in the housing by at least one latch element. The connection between the latch recess and the latch element counteracts the spring force of the flexible conduction bands.

The board can be fixed in its exact position to the housing when latch recesses are provided at the edges of the board and corresponding latch elements are provided at the housing. In the installation situation, a correctly oriented positioning of the board is in particular realized before a cover of the motor housing is positioned in place. This provides for a good monitoring of the positioning.

The present invention is hereinafter described in detail on the basis of an embodiment with reference to the accompanying drawings.

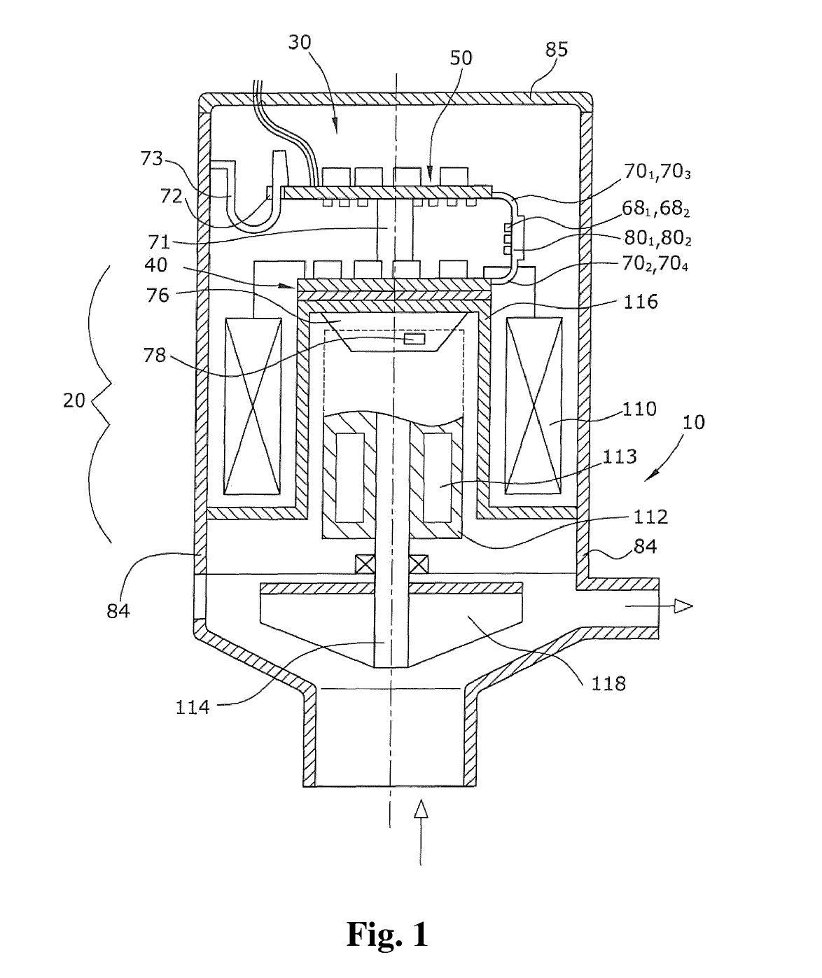

FIG. 1 shows a longitudinal section of an electronic vehicle fluid pump 10. The electronic vehicle fluid pump 10 serves to supply a vehicle internal combustion engine with a cooling agent, for example, water. The electronic vehicle fluid pump 10 essentially comprises a motor housing 84 having a motor housing cover 85 in which an electronically commutated drive motor 20 is arranged. The drive motor 20 comprises a motor stator 110 at its stator side and a motor rotor 112 with inserted permanent magnets 113 at its rotor side.

The electronically commutated drive motor 20 comprises a separating can 116 so that the overall motor rotor 112, including the permanent magnets 113, is arranged in the wet area. The motor rotor 112 is attached to rotate with a pump impeller 118 via a motor rotor shaft 114. The motor stator 110 is shielded in a fluid-tight manner by the separating can 116. The wet area is separated from the dry motor stator 110 and an electronic motor control unit 30 by the separating can 116.

The motor control unit 30 comprises a flexible board structure having a first main board 40 and a second main board 50. Between the first main board 40 and the second main board 50, two intermediate boards 80₁-80₂ are arranged via flexible conduction bands 70₁-70₄. In the installed state, the first main board 40, the second main board 50, and the intermediate boards 80₁-80₂ are folded with respect to each other so that they form a U-shape, so that the first main board 40 and the second main board 50 are arranged opposite to each other.

The first main board 40 is populated on one side. The second main board 50 is populated on two sides. The unpopulated side of the first main board 40 is thermally connected with the separating can 116 via a heat conductor. The motor control unit 30 further comprises a sensor board 76. This sensor board 76 is electrically connected with the second main board 50 and is populated with a rotor position sensor 78. The rotor position sensor 78 is realized as a Hall sensor according to the illustrated embodiment. The rotor position sensor 78 of the sensor board 76 is arranged in the area of the motor rotor 112.

The second main board 50 is fixed in the motor housing 84 of the electronic vehicle fluid pump 10 via at least one latch recess 72 by a housing-side latch element 73. The connection between the latch recess 72 and the latch element 73 is arranged so that it counteracts the spring force of the flexible conduction bands 70₁-70₄.

The unpopulated side of the first main board 40 is placed onto the separating can 116 via a heat conductor. In this situation, the flexible circuit board structure is still in its non-folded state. If the motor housing cover 85 of the motor housing 84 of the electronic vehicle fluid pump 10 is then placed onto the separating can 116, the flexible conduction bands 70₁-70₄ deform and the first main board 40 and the second main board 50 together with the intermediate boards 80₁-80₂ form a U-shaped configuration.

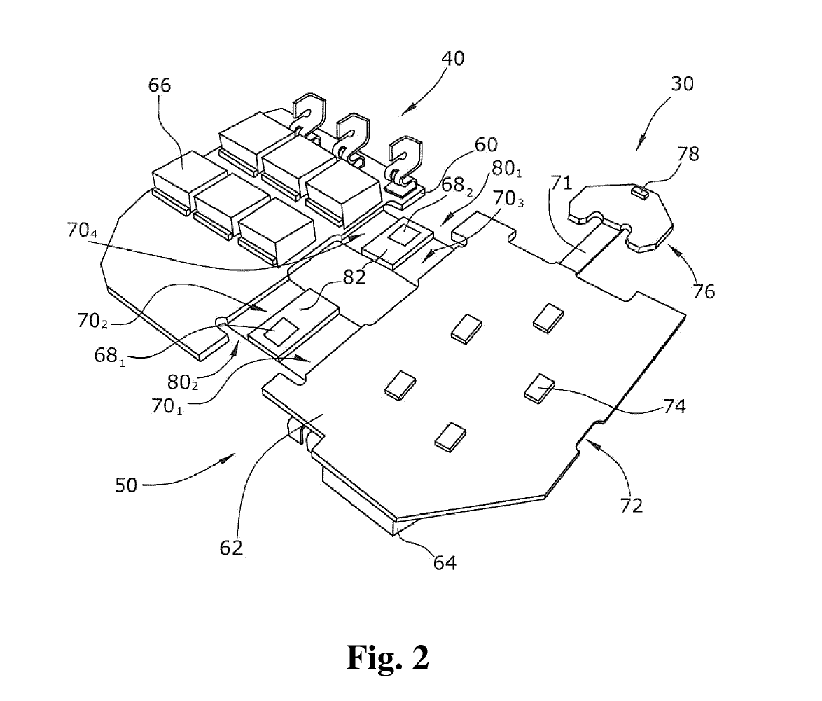

FIG. 2 shows the motor control unit 30 of FIG. 1 in its unfolded state. The motor control unit 30 comprises a first main board 40, a second main board 50, and two intermediate boards 80₁-80₂ which are mechanically and electrically connected with each other via flexible conduction bands 70₁-70₄ or are coupled with each other. The flexible conduction bands 70₁-70₄ are connected integrally and in a plug-free manner with the first main board 40 and the second main board 50 as well as with the intermediate boards 80₁-80₂. The first main board 40 is populated on one side. The first main board 40 comprises a plurality of power semiconductors 66 on the populated side. It represents the power board 60. The first main board 40 is electrically and mechanically connected with a second main board 50 via the flexible conduction bands 70₁-70₄. Two intermediate boards 80₁-80₂ are arranged on the flexible conduction bands 70₁-70₄. These intermediate boards 80₁-80₂ comprise at least one electronic component 68₁-68₂. This electronic component 68₁-68₂ defines, for example, a signal-decoupling electronic unit 82.

In contrast to the first main board 40, the second main board 50 is populated on two sides. The second main board 50 comprises, for example, a plurality of signal-processing components 74 on one populated side, and a processor 64 on the other populated side. The second main board 50 represents the signal-processing board 62. The base area of the second main board 50 comprises a latch recess 72 via which the flexible circuit board is fixed to the motor housing 84 via a latch element 73.

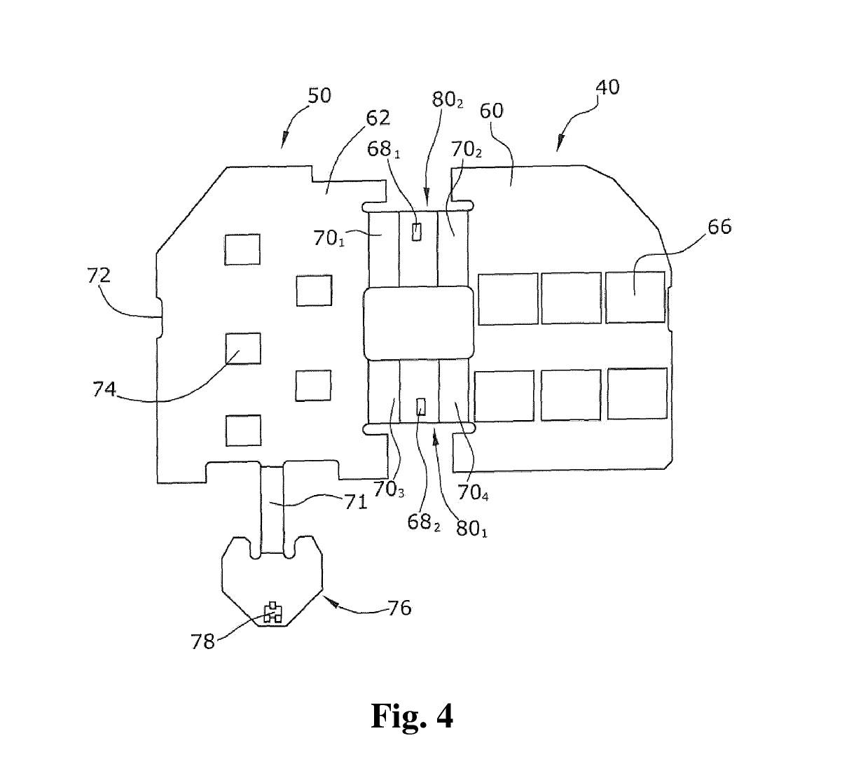

A separate sensor board 76 is connected with the signal-processing board 62 via a flexible conduction band 71. The signal-processing board 62 includes at least one rotor position sensor 78. The rotor position sensor 78 is configured as a Hall sensor, as is shown in FIG. 4.

On the whole, the unfolded arrangement of the first main board 40 and the second main board 50 has a butterfly-type symmetry.

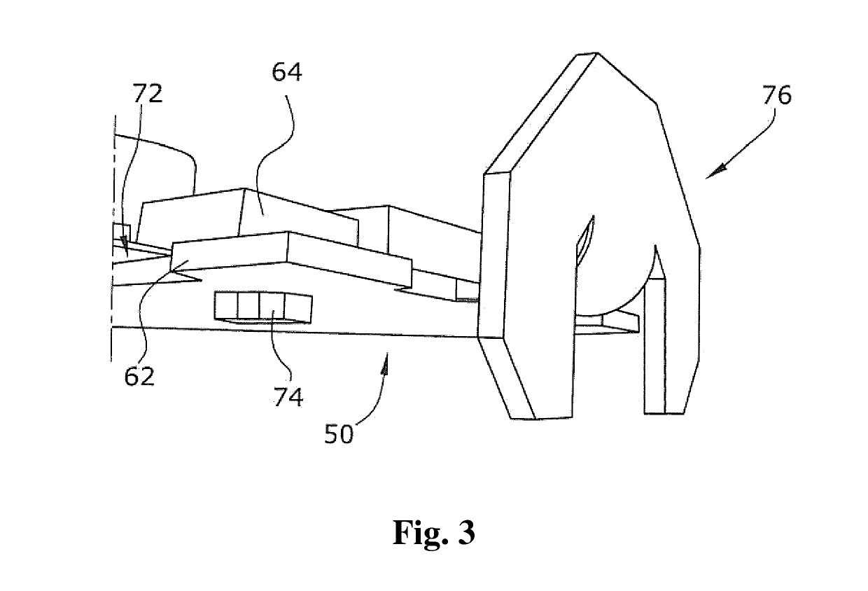

FIG. 3 illustrates a representation of the flexible circuit board structure having a folded-up sensor board 76. The folded-up sensor board 76 here lies at a spatial level deviating from the second main board 50. The sensor board 76 is mechanically and electrically connected with the second main board 50 via another flexible conduction band 71. In a similar manner as with the flexible conduction bands 70₁-70₄, this is an integral and plug-free connection.

The sensor board 76 comprises a rotor position sensor 78 for the detection of the current position of the motor rotor 112. The rotor position sensor 78 is configured as a Hall sensor according to this exemplary embodiment. The Hall sensor is arranged in the edge area of the sensor board 76.

FIG. 4 illustrates a top view of the flexible circuit board structure with the electronic components 68₁-68₂ placed thereon.

The present invention is not limited to embodiments described herein; reference should be had to the appended claims.

### LIST OF REFERENCE NUMERALS

10 Electronic vehicle fluid pump

20 Electronically commutated drive motor

30 Electronic motor control unit

40 First main board

50 Second main board

60 Power board

62 Signal-processing board

64 Processor

66 Power semiconductor

68₁-68₂ Electronic component

70₁-70₄ Flexible conduction bands

71 Flexible conduction band

72 Latch recess

73 Latch element

74 Signal processing component

76 Sensor board

78 Rotor position sensor

80₁-80₂ Intermediate board

82 Signal-decoupling electronic unit

84 Motor housing

85 Motor housing cover

110 Motor stator

112 Motor rotor

113 Permanent magnet

114 Motor rotor shaft

116 Separating can

118 Pump impeller

120 Stator coils

What is claimed is:

1-13. (canceled)

14. An electronic vehicle fluid pump comprising an electronically commutated drive motor, the electronically commutated drive motor comprising an electronic motor control unit which comprises:
a first main board;
a second main board,
at least one flexible conduction band;
at least one intermediate board arranged between the first main board and the second main board and electrically connected with the first main board and the second main board via the at least one flexible conduction band; and
at least one electronic component arranged on the at least one intermediate board;
wherein,
the first main board, the second main board, and the at least one intermediate board are respectively arranged at a different spatial level.

15. The electronic vehicle fluid pump as recited in claim 14, wherein the electronic motor control unit is arranged to have a butterfly-type symmetry of the first main board and the second main board.

16. The electronic vehicle fluid pump as recited in claim 14, wherein the first main board, the second main board, and the at least one intermediate board are folded with respect to each other to form a U-shape.

17. The electronic vehicle fluid pump as recited in claim 14, wherein each of the at least one flexible conduction band is connected integrally and in a plug-free manner with the associated first main board, second main board, and the at least one intermediate board.

18. The electronic vehicle fluid pump as recited in claim 14, further comprising a signal-decoupling electronic unit arranged on the at least one intermediate board.

19. The electronic vehicle fluid pump as recited in claim 14, wherein the first main board defines a power board comprising a plurality of power semiconductors.

20. The electronic vehicle fluid pump as recited in claim 19, wherein the power board comprises a first side and a second side, and the power board is populated on the first side and is unpopulated on the second side.

21. The electronic vehicle fluid pump as recited in claim 20, further comprising:
a heat conductor; and
a separating can,
wherein, the second side of the power board is thermally connected with the separating can housing via the heat conductor.

22. The electronic vehicle fluid pump as recited in claim 19, wherein the second main board defines a signal-processing board comprising signal-processing components.

23. The electronic vehicle fluid pump as recited in claim 22, wherein the signal-processing board further comprises a processor.

24. The electronic vehicle fluid pump as recited in claim 22, further comprising:
a flexible conduction band; and
a separate sensor board connected with one of the first main board or the second main board via the at least one flexible conduction band.

25. The electronic vehicle fluid pump as recited in claim 24, wherein the separate sensor board is connected with the signal-processing board.

26. The electronic vehicle fluid pump as recited in claim 24, wherein the separate sensor board is populated with a rotor position sensor.

27. The electronic vehicle fluid pump as recited in claim 26, wherein the rotor position sensor is a Hall sensor.

28. The electronic vehicle fluid pump as recited in claim 22, wherein the signal-processing board comprises a first side and a second side, and the signal-processing board is populated on each of the first side and the second side.

29. The electronic vehicle fluid pump as recited in claim 19, further comprising:
a housing; and
at least one latch element,
wherein, at least one of the power board and the signal-processing board is/are fixed in the housing via the at least one latch element so as to counteract a spring force of the at least one flexible conduction band.
